(19) United States
(12) Patent Application Publication
(10) Pub. No.: US 2008/0100949 A1
(43) Pub. Date: May 1, 2008

(54) Automatic stop mechanisms for tape recorders

(75) Inventor: Yung Ta Chen, Shenzhen (CN)

Correspondence Address: MORGAN LEWIS & BOCKIUS LLP, 1111 PENNSYLVANIA AVENUE NW, WASHINGTON, DC, 20004, US

(73) Assignee: Valley Wood Limited, Hong Kong (CN)

(21) Appl. No.: 11/976,584

(22) Filed: Oct. 25, 2007

(30) Foreign Application Priority Data
Oct. 27, 2006 (CN) 200620015448.1

(51) Int. Cl. G11B 15/18; G11B 15/093

(52) U.S. Cl. 360/74.2

(57) ABSTRACT

Disclosed is an automatic stop mechanism for a tape recorder comprising a circular member having a driving pin, a swing member hinged onto a main board of the recorder, a driving member which can make the swing member push a locking level to move transversely, and a torsion spring member configured to make the end portion of the driving arm cling to the periphery of the cam when a stop button of the tape recorder is pressed down. The automatic stop mechanism can achieve the automatic stop in every work state.

### CROSS-REFERENCE OF RELATED APPLICATION

The present application claims benefit of Chinese application No. 200620015448.1 filed on Oct. 27, 2007 which is incorporated herein as its entirety.

### FIELD OF THE INVENTION

The present invention generally relates to a device equipped in a tape recorder, and more particular to an automatic stop mechanism for a tape recorder.

### BACKGROUND OF THE INVENTION

A tape recorder has a plurality of buttons which control the operation of the recorder in respective states such as recording, playing, fast feeding and rewinding. Generally all the buttons of the tape recorder are arranged parallel to each other and can move longitudinally. Meanwhile the recorder is provided with a locking level which is perpendicular to the buttons and can move transversely.

The locking level is provided with a plurality of locking hooks having an inclined surface positioned relative to each button. When one of the buttons is pressed, it can make the locking level move transversely by pushing the inclined surface of the locking hook. Afterwards the locking level, upon the force of a spring, blocks the button thus making it unrestored, which assures the recorder works in the state the button controls. When the recorder is working, the locking of the button can be released as long as the locking level is moved transversely under a force.

When the recorder finishes working in each of the working states including recording, playing, fast feeding and rewinding, an automatic stop mechanism of the recorder provides a force to push the locking level to move transversely so as to make the recorder return to the initial state, a non-working state.

Chinese utility model patent 98243377.8 provides an automatic stop mechanism for a recorder, which makes an improvement to the prior art. However, the mechanism in this Chinese utility model patent can be further improved.

### SUMMARY OF THE INVENTION

One aspect of the present invention is to provide an automatic stop mechanism which has a simple structure and can operate more stably and reliably.

An automatic stop mechanism for a tape recorder according to the present invention, comprises: a circular member being disposed at one end of a take-up reel and having a driving pin extended longitudinally from the circumference thereof; a swing member hinged onto a main board of the tap recorder, having a shaft, a sensing arm that can rotate around the shaft, a hole provided at one end of the arm, which receives the driving pin, and a driving arm extended from the shaft, having an end portion, wherein the driving pin moves in an arc track within the hole to apply a force to the swing member so as to generate a torque in one direction; a driving member disposed onto an end surface of a flywheel driven by a motor, which can make the driving arm push a locking level to move transversely, comprising a cam being located onto the end surface of a flywheel and being coaxial therewith and a block located at a side of the cam that forms a channel with the block to allow the end portion of the driving arm to slide therethrough; and a torsion spring member configured to make the end portion of the driving arm cling to the periphery of the cam when a stop button is pressed down.

In one of preferred embodiments of the present invention, the torsion spring member has a first arm and a second arm, wherein when the stop button is pressed down to contact the first arm, the second arm can press the sensing arm such that the end portion of the driving arm clings to the periphery of the cam.

Preferably, an angle between a line through one end point of the block which is far from the peak of the cam and the center of the cam and the largest diameter of the cam is defined about 10-15°; and in one more preferred embodiment of the present invention, the angle is defined about 12°.

In another preferred embodiment of the present invention, the circular member is rotatably mounted to the take-up reel by means of a sleeve fixed onto a shaft of the take-up reel and housed by a spring located between an annular part of the sleeve extended outward from one end thereof and the circular member; and wherein another spring is disposed between another annular part of the sleeve extended inward from another end thereof and the main board.

In a further preferred embodiment of the present invention, the flywheel is integrally formed, including a disc-shape body and two hollow belt pulleys being extended perpendicularly from two end surfaces thereof and being coaxial therewith, the cam and the block of the driving member being within one of the two hollow belt pulleys of which the diameter is smaller.

The automatic stop mechanism of tape recorders according to the present invention can achieve automatic stop by moving the locking lever transversely by means of a rotary member which senses whether the take-up reel is rotating together with the driving member disposed on the flywheel, which has a simply structure, less elements and lower costs.

Furthermore, since the torsion spring member for controlling the swing member is provided, choking problem caused by the swing member can be avoided and the recorder equipped with the stop mechanism is more reliable.

Moreover, as the flywheel comprising two belt pulleys and a balance weight is made integrally, the stop mechanism of the present invention is not only more reliable, but also simpler while assembled, compared to the art. Besides, an arrangement of the cam and the block according to the invention renders noise of transmission to be effectively decreased.

### BRIEF DESCRIPTION OF THE DRAWINGS

Other aspects, features and advantages of the present invention will become apparent from the following detailed description when read with reference to the accompanying drawings, in which:

FIG. 1 is a schematic view of a main board of a tape recorder on which an automatic stop mechanism according to the present invention is mounted, illustrating the mounting position of the automatic stop mechanism;

FIG. 2 is a sectional view of a take-up reel mounted with a rotary member;

FIGS. 3 and 4 are plan views of a swing member, illustrating a driving pin of the circular member applying a force to the swing member at point A and point B, respectively;

FIG. 5 is a perspective view of a flywheel (with a shaft) of the tape recorder;

FIG. 6 is a top view of the flywheel (without a shaft) as shown in FIG. 5;

FIG. 7 is a sectional view taken along the line A-A of FIG. 6;

FIGS. 8-12 are schematic views illustrating the operation of the automatic stop mechanism according to the present invention; and

FIGS. 13 and 14 are schematic views illustrating working process of a torsion spring member for controlling the swing member.

### DETAILED DESCRIPTION OF THE PREFERRED EMBODIMENTS

Hereinafter, preferred embodiments of the present invention will be described in detail with reference to the accompanying drawings.

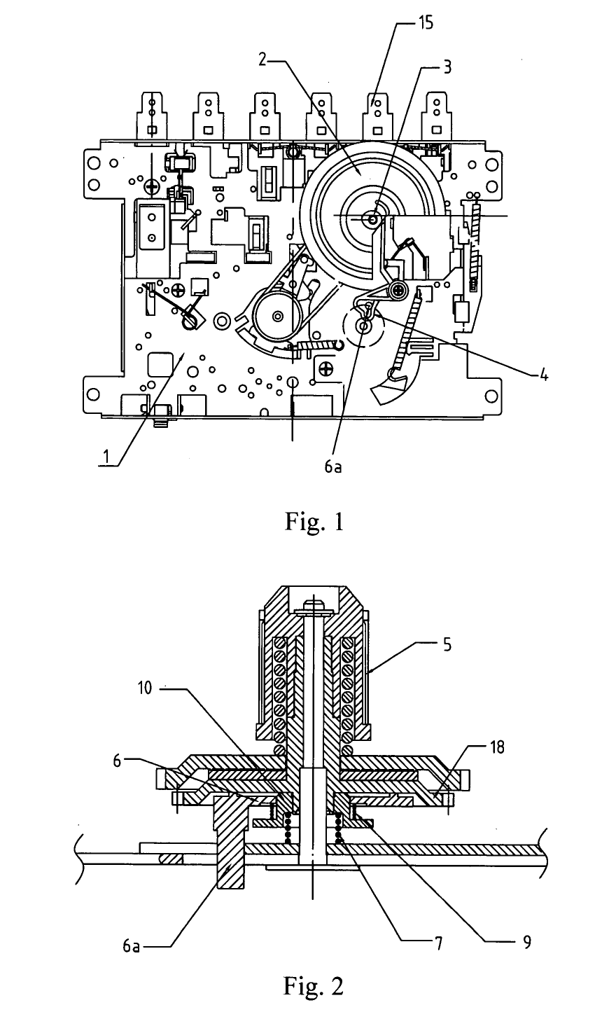

Referring to FIG. 1, a flywheel 2 and a swing member 4 are disposed onto a main board 1 of a tape recorder; a take-up reel 5 (not shown in FIG. 1) is mounted on the left side of the back of the main board 1.

Referring to FIG. 2, a circular member 6 having a driving pin 6a is disposed between an end surface of the take-up reel 5 and the main board 1. The circular member 6 is rotatably mounted to the take-up reel 5 by means of a sleeve 10 and can rotate around the sleeve 10. The sleeve 10 is fixed onto a shaft of the take-up reel 5 and housed by a compression spring 9 located between an annular part of the sleeve 10 extended outward from one end thereof and the circular member 6, and another compression spring 7 is disposed between another annular part of the sleeve 10 extended inward from another end thereof and the main board 1.

When the take-up reel 5 rotates, a friction force will be generated between the circular member 6 and the end surface of a gear 18 of the take-up reel 5. The friction force depends on the compressive force of the compression spring 9 due to being compressed. The compression spring 9 has stable performance and has little deformation at different temperatures, so that the pressure of the compression spring 9 applying to the member 6 is stable. As a result, in case the coefficient of friction between the gear 18 and the member 6 is invariable, the friction force of the take-up reel 5 applying to the member 6 is stable when the take-up reel 5 rotates. Thus the sensing pushing force of the driving pin 6a of the member 6 is substantially invariable, which equals to the friction force between the gear 18 and the member 6.

To keep the sensing pushing force of the driving pin 6a of the member 6 stable is important to operate well for the automatic stop mechanism of the present application.

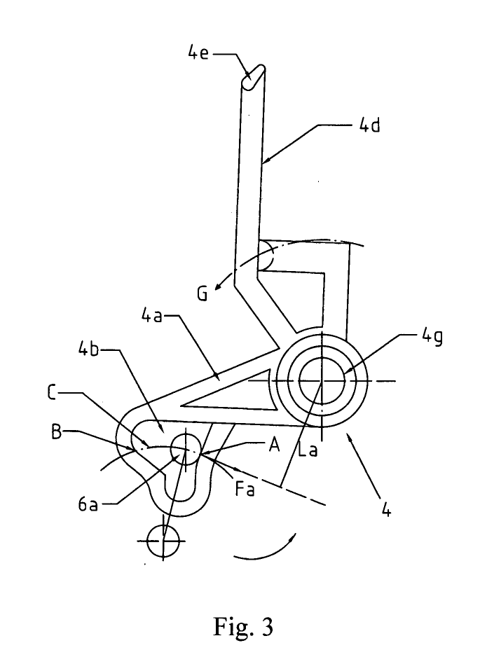

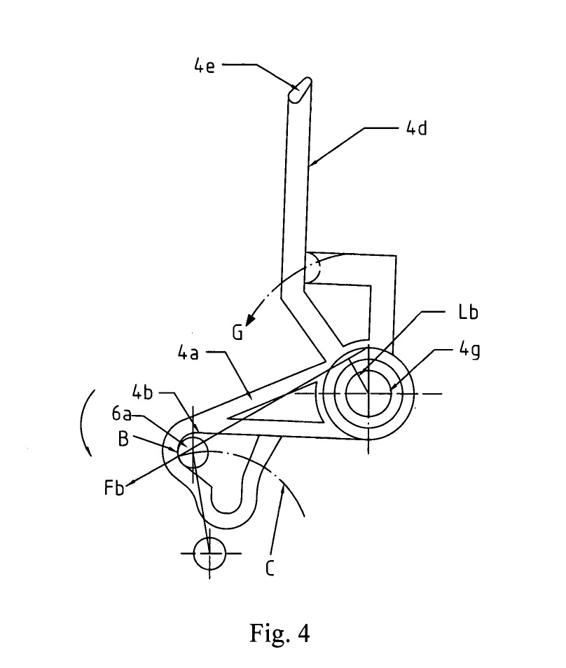

Referring to FIGS. 1, 3 and 4, the swing member 4 is hinged onto the main board 1 and can rotate around a shaft 4g. The swing member 4 provides a sensing arm 4a, a hole 4b and a driving arm 4d. The driving pin 6a of the member 6 can move in an arc track C within the hole 4b and meet with the hole 4b at two points A and B on the inner wall of the hole as shown in FIGS. 3 and 4, where the driving pin 6a applies a force to the swing member 4.

Also as shown in FIG. 3, when the driving pin 6a applies a force Fa to the swing member 4 at the point A, the arm of force is La and the direction of the torque for the swing member 4 thus generated is anticlockwise as shown by an arrow G.

As shown in FIG. 4, when the driving pin 6a applies a force Fb to the swing member 4 at the point B, the arm of force is Lb and the direction of the torque for the swing member 4 thus generated is also anticlockwise as shown by an arrow G Therefore, when the driving pin 6a applies a force to the swing member 4 at either point A or point B, the swing member 4 always rotates around the shaft 4g in an anticlockwise direction. In other words, when the take-up reel 5 rotates either clockwise or anticlockwise, the driving pin 6a will have the torque in the same direction for the swing member 4, thereby making the driving arm 4d rotate in one direction.

The automatic stop mechanism according to the present invention also comprises a driving member 3 which can make the driving arm 4d of the swing member 4 rotate at a large angle, thus pushing a locking level 8 to move transversely to stop the recorder's operation.

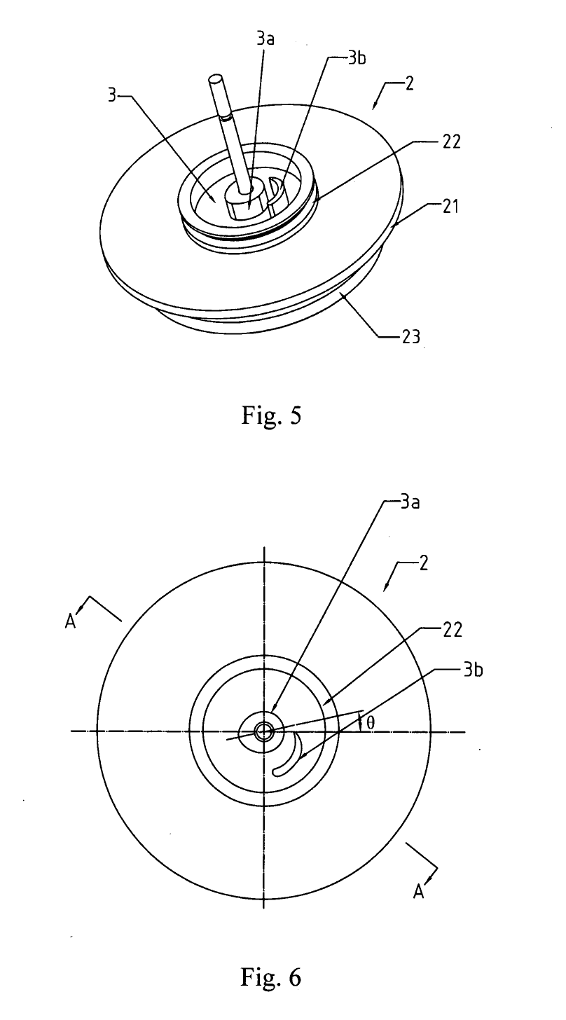

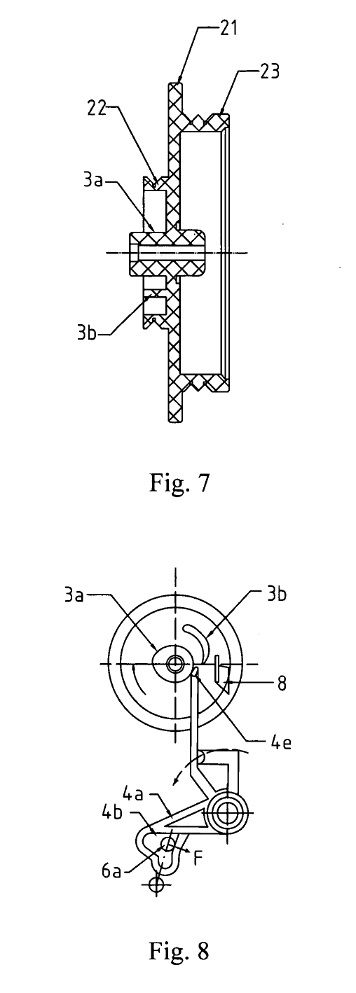

Now referring to FIGS. 5-7, the driving member 3 comprises a cam 3a located onto one end surface of the flywheel 2 and being coaxial with the flywheel 2, and a block 3b located at a side of the cam 3a. The flywheel 2 is driven by a motor. During the rotation of the flywheel 2, an end portion 4e of the driving arm 4d of the swing member 4 can slide through either a channel defined by the block 3b and the cam 3a or an outside of the block 3b. In this embodiment, the flywheel 2 has an integral structure which includes a disc-shape body 21 and two hollow belt pulleys 22 and 23 extended perpendicularly from two end surfaces of the disc-shape body 21 respectively and being coaxial with the disc-shape body 21. The cam 3a and the block 3b of the driving member 3 are inside the hollow belt pulley 22 of which the diameter is smaller than that of the hollow belt pulley 23. Because the belt pulleys 22 and 23 are integrally formed with the disc-shape body 21 which functions as a balance weight, the flywheel 2 provided in the present invention is more stable and reliable over the prior art.

According to the present invention, an angle θ between the line through one end point of the block 3b which is far from the peak of the cam 3a and the center of the cam 3a and the largest diameter of the cam 3a is preferably from about 10° to 15° with which the noise of the operation can be significantly reduced. In a more preferred embodiment, as shown in FIG. 6, the angle θ is defined around 12°.

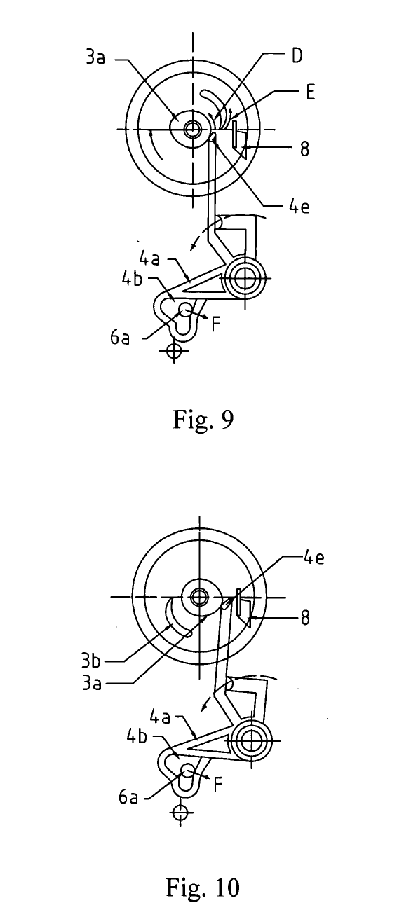

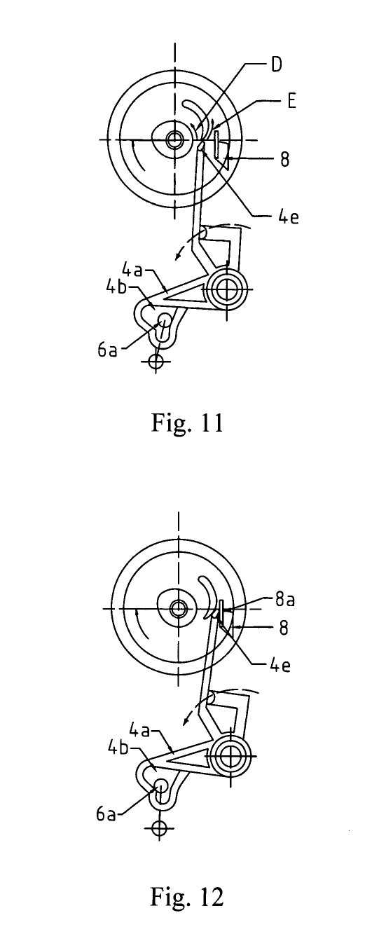

Referring now to FIGS. 8-12, the operation of the automatic stop mechanism according to the present invention will be explained below.

When the tape recorder is in a working state including playing, fast feeding and rewinding, the member 6 is driven by the take-up reel 5 to rotate (either clockwise or anticlockwise), thus making the driving pin 6a continuously apply a force to the hole 4b of the swing member 4. The swing member 4 generates to swing around the shaft 4g anticlockwise, which makes the end portion 4e of the driving arm 4d of the swing member 4 slide along the periphery of the cam 3. It assures that the end portion 4e of the driving arm 4a of the swing member 4 can only slide through the inside of the block 3b (i.e. the channel D). Therefore the driving arm 4a can swing within a small range which equals to the eccentric distance of the cam 3 and cannot push the locking level 8 to move transversely.

When the tape turns to the end, the take-up reel 5 stops rotating and its end surface no longer rubs the member 6. Then the driving pin 6a no longer applies a force to the hole 4b of the swing member 4, which makes the end portion 4e of the driving arm 4d of the swing member 4 not cling to the periphery of the cam 3a. Instead, the end portion 4e of the driving arm 4d, upon the driving of the cam 3a which is still rotating, swings apart from the cam 3a to contact the block 3b. Afterwards the block 3b which is rotating drives the end portion 4e of the driving arm 4d of the swing member 4 to slide along its outside (i.e. the channel E) so as to push the locking level 8 to move transversely towards the right (see the FIG. 12), thereby releasing the operating button to stop the operation of the tape recorder.

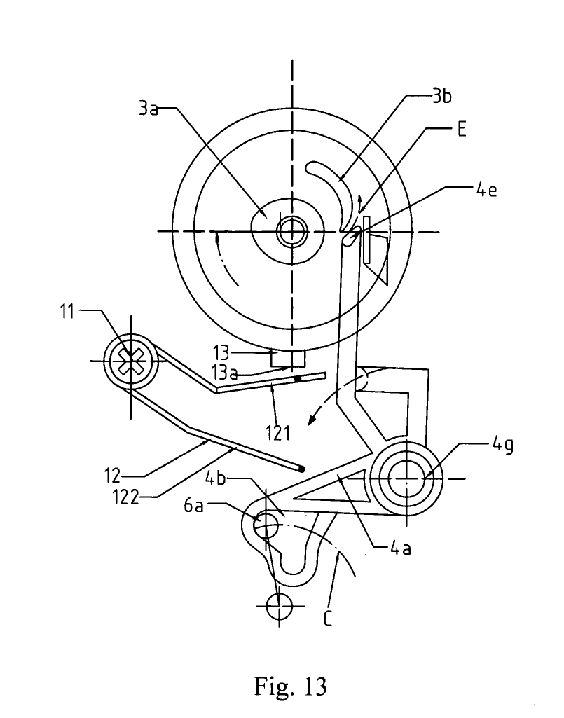

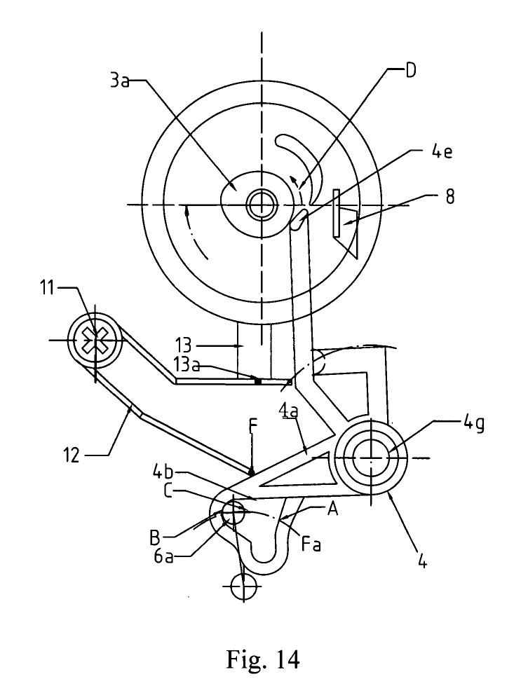

Referring to FIGS. 13 and 14, a torsion spring member 12 is provided in the present invention that is disposed between a distal end 13 of a stop button 15 (see the FIG. 1) and the sensing arm 4a of the swing member 4 and is hinged onto the main board 1 via a shaft 11. The spring member 12 has two arms 121, 122. When the stop button 15 is pressed down to contact the arm 121, the arm 122 can press the sensing arm such that the end portion 4e of the driving arm 4d clings to the periphery of the cam 3.

At a working state of racing, playing, recording, fast feeding and fast receding (i.e. the stop button is not pressed down), the spring member 12 is separated from the swing member 4 and does not affect the working of the tape recorder, as shown in FIG. 13. However, as shown in FIG. 14, when the stop button is pressed down, an end 13a of a pushing rod 13 of the stop button 15 presses the spring member 12 to make it apply a force to the sensing arm 4a of the swing member 4. Therefore the end portion 4e of the driving arm 4d of the swing member 4 slides in the channel between the block 3b and the cam 3a, which will avoid the following problem in the art. Before the stop button 15 is released, the take-up reel 5 stops rotating but the flywheel 2 is still rotating which will cause the end portion 4e of the driving arm 4d of the swing member 4 that freely slides to the outside of the block 3b and block the locking lever 8, without a force the spring member 12 applies to the swing member 4. In this case, the tape recorder cannot work well.

The preferred embodiments shown and described above are only to illustrate the present invention and should not be construed any limitation to the present invention. It is understood that various modifications and alterations to the embodiments of the invention without departing from the spirit of the present invention, can be made for those skilled in the art.

1. An automatic stop mechanism for a tape recorder, comprising
a circular member being disposed at one end of a take-up reel and having a driving pin extended longitudinally from the circumference thereof;
a swing member hinged onto a main board of the tape recorder, having
a shaft,
a sensing arm that can rotate around the shaft,
a hole provided at one end of the arm, which receives the driving pin, and
a driving arm extended from the shaft, having an end portion,
wherein the driving pin moves in an arc track within the hole to apply a force to the swing member so as to generate a torque in one direction;
a driving member disposed onto an end surface of a flywheel driven by a motor, which can make the driving arm push a locking level to move transversely, comprising:
a cam being located onto the end surface of a flywheel and being coaxial therewith, and
a block located at a side of the cam that forms a channel with the block to allow the end portion of the driving arm to slide therethrough; and
a torsion spring member configured to make the end portion of the driving arm cling to the periphery of the cam when a stop button of the tape recorder is pressed down.

2. The automatic stop mechanism for a tape recorder of claim 1, wherein the torsion spring member has a first arm and a second arm, wherein when the stop button is pressed down to contact the first arm, the second arm can press the sensing arm such that the end portion of the driving arm clings to the periphery of the cam.

3. The automatic stop mechanism for a tape recorder of claim 1, wherein an angle between a line through one end point of the block which is far from the peak of the cam and the center of the cam and the largest diameter of the cam is defined from about 10° to about 15°.

4. The automatic stop mechanism for a tape recorder of claim 3, wherein the angle is defined about 12°.

5. The automatic stop mechanism for a tape recorder of claim 1, wherein the circular member is rotatably mounted to the take-up reel by means of a sleeve fixed onto a shaft of the take-up reel and housed by a spring located between an annular part of the sleeve extended outward from one end thereof and the circular member; and wherein another spring is disposed between another annular part of the sleeve extended inward from another end thereof and the main board.

6. The automatic stop mechanism for a tape recorder of claim 2, wherein the circular member is rotatably mounted to the take-up reel by means of a sleeve fixed onto a shaft of the take-up reel and housed by a spring located between an annular part of the sleeve extended outward from one end thereof and the circular member; and wherein another spring is disposed between another annular part of the sleeve extended inward from another end thereof and the main board.

7. The automatic stop mechanism for a tape recorder of claim 3, wherein the circular member is rotatably mounted to the take-up reel by means of a sleeve fixed onto a shaft of the take-up reel and housed by a spring located between an annular part of the sleeve extended outward from one end thereof and the circular member; and wherein another spring is disposed between another annular part of the sleeve extended inward from another end thereof and the main board.

8. The automatic stop mechanism for a tape recorder of claim 4, wherein the circular member is rotatably mounted to the take-up reel by means of a sleeve fixed onto a shaft of the take-up reel and housed by a spring located between an annular part of the sleeve extended outward from one end thereof and the circular member; and wherein another spring is disposed between another annular part of the sleeve extended inward from another end thereof and the main board.

9. The automatic stop mechanism for a tape recorder of claim 1, wherein the flywheel is integrally formed, including a disc-shape body and two hollow belt pulleys being extended perpendicularly from two end surfaces thereof and being coaxial therewith, and the cam and the block of the driving member are within one of the two hollow belt pulleys of which the diameter is smaller.

10. The automatic stop mechanism for a tape recorder of claim 2, wherein the flywheel is integrally formed, including a disc-shape body and two hollow belt pulleys being extended perpendicularly from two end surfaces thereof and being coaxial therewith, and the cam and the block of the driving member are within one of the two hollow belt pulleys of which the diameter is smaller.

11. The automatic stop mechanism for a tape recorder of claim 3, wherein the flywheel is integrally formed, including a disc-shape body and two hollow belt pulleys being extended perpendicularly from two end surfaces thereof and being coaxial therewith, and the cam and the block of the driving member are within one of the two hollow belt pulleys of which the diameter is smaller.

12. The automatic stop mechanism for a tape recorder of claim 4, wherein the flywheel is integrally formed, including a disc-shape body and two hollow belt pulleys being extended perpendicularly from two end surfaces thereof and being coaxial therewith, and the cam and the block of the driving member are within one of the two hollow belt pulleys of which the diameter is smaller.

13. The automatic stop mechanism for a tape recorder of claim 5, wherein the flywheel is integrally formed, including a disc-shape body and two hollow belt pulleys being extended perpendicularly from two end surfaces thereof and being coaxial therewith, and the cam and the block of the driving member are within one of the two hollow belt pulleys of which the diameter is smaller.
